(19) United States
(12) Patent Application Publication
(10) Pub. No.: US 2022/0407231 A1
(43) Pub. Date: Dec. 22, 2022

(54) WIDEBAND ELECTROMAGNETICALLY COUPLED MICROSTRIP PATCH ANTENNA FOR 60 GHZ MILLIMETER WAVE PHASED ARRAY

(71) Applicant: INDIAN INSTITUTE OF TECHNOLOGY KHARAGPUR, kharagpur (IN)

(72) Inventors: Saswati GHOSH, Kharagpur (IN); Debarati SEN, Kharagpur (IN)

(21) Appl. No.: 17/780,554

(22) PCT Filed: Nov. 28, 2020
(86) PCT No.: PCT/IB2020/061249

§ 371 Date: May 27, 2022

(30) Foreign Application Priority Data
Nov. 30, 2019 (IN) 201931030816

(51) Int. Cl. H01Q 9/04; H01Q 1/42; H01Q 13/10

(52) U.S. Cl. CPC H01Q 9/045; H01Q 1/422; H01Q 13/10

(57) ABSTRACT

The present invention discloses a broadband microstrip patch antenna (106) with U-shaped slot (116) with unequal arms for millimeter wave communications. The electromagnetic coupled type feed is used with microstrip line (103) printed on another substrate layer to minimize feed loss. The dimension of the patch, position and dimension of slots, height of dielectric layer, length, width of the microstrip line and so on are optimized to achieve the desired impedance and gain pattern over the 60 GHz frequency band.

### TECHNICAL FIELD OF THE INVENTION

The present subject matter described herein relates to the field of printed-circuit antenna element, particularly to a microstrip antenna and more particularly to a microstrip patch antenna for millimeter wave phased array.

### BACKGROUND OF THE INVENTION

The increasing demand of wireless data traffic in recent years has triggered the use of the 60 GHz (57-64 GHz) millimeter wave (mm-wave) frequency range for the future generation communication systems. However, millimeter wave communication has some characteristics which are different from other existing narrow-band communication systems operating in microwave frequency range (e.g. 2.4 GHz and 5 GHz band). The millimeter wave communications suffer from sensitivity to blockage due to weak diffraction capability, huge propagation loss due to the high carrier frequency, high losses due to atmospheric oxygen and water vapor. These characteristics set new challenges in the antenna design technologies, placing the requirement of improved system.

The antenna beam-forming technology employing multiple antennas is found as a viable solution to increase the link capacity by allowing directional communication. The design of appropriate antenna and antenna array which can be integrated with other circuitry e.g. front end detector and amplifier circuits becomes necessary for this purpose. The leaky-wave antennas, integrated and micro-strip antennas are commonly used for millimeter-wave communications. The micro-strip antennas are preferred due to the attractive features like light weight, low profile, low production cost, ease of integration with other components and so on. However, they have several disadvantages. Narrow impedance bandwidth, low gain, substrate loss are some of the drawbacks of the existing microstrip antennas. Also, while using these antennas in the millimeter wave frequency ranges, the substrates may be electrically thicker and have higher dielectric constants than at lower frequencies. The input impedance and bandwidth of the antenna gets affected due to the substrate thickness. The surface waves and mutual coupling degrade the electrical performance of the microstrip antennas. Additionally, the dielectric and feeding loss highly influence the performance of these antennas atmm-wave frequencies.

The micro-strip bow-tie, vivaldi, spiral antenna, printed yagi antenna, planar patch antenna array have been used earlier in the 60 GHz unlicensed band. In some structures, the bandwidth and radiation efficiency is improved by using air-cavity and resonating aperture. The spurious radiation from feed network is restricted by using superstrate material of high dielectric constant. The design of millimeter wave 5G antenna module and its implementation within fully operating cellular handset at the 60 GHz spectrum is presented in the literature “J. Saini, S. K. Agarwal, ‘Design a single band microstrip patch antenna at 60 GHz millimeter wave for 5G application,’ IEEE International Conference on Computer, Communications and Electronics (Comptelix) 2017”. There are several planar antenna structures existing in the art for 60 GHz communications, for e.g. micro-strip patch, elliptical dipole and broadband probe-fed micro-strip patch antenna.

Reference is made to U.S. Pat. No. 10,062,965B2 that discloses large impedance bandwidth achieved using raised antenna patch with air dielectric. For the same, the frequency range of operation is 27.5-29.5 GHz.

Another reference is made to U.S. Pat. No. 6,037,911A that discloses a plurality of dipole each comprising a first and second element used to achieve broadband performance. For such dipole the influence of the feeding network on the radiation pattern is much lower due to the balanced microstrip feed line structure.

Still another reference is made to US2011/0057853 that discloses a patch antenna which includes a multi-layer substrate. Therein the vias are disposed around the center region through the dielectric layers to reduce the signal leakage from the microstrip transmission line in the form of surface waves.

Yet another reference is made to U.S. Pat. No. 7,486,156B2 that discloses microstrip to waveguide transition sections. It transfers a signal from the microstrip line to a waveguide-shaped antenna like a horn antenna and has broadband characteristic. It consists of microstrip line, slot, microstrip patch and waveguide section.

Again, another reference is made to CN107978858A that discloses the antenna which consists of four dielectric layers of different thickness. The surface area covered by the antenna is quite large ˜14×13.3 mm². The antenna can be used for directional radiation without the use of expensive phase shifter though the accuracy is poor compared to the phased array antenna.

Further, reference is made to KR100674200B1 that discloses the microstrip patch antenna with three U-slots and two dielectric layers. The resonance frequency of the antenna is 5.15 GHz with impedance bandwidth of 450 MHz. The probe feed technique is used.

Reference is made to IN201731016236 that discloses the antenna consisting of microstrip square patch with square ring enclosure and excited by a single cross type feed. The substrate material used is arlon consisting of two layers. The antenna is used for Wi-MAX/WLAN communication systems at 3.5 GHz and 5.5 GHz frequencies.

Reference is also made to KR20000020659A which discloses the antenna consisting of four dielectric layers which make the antenna size sufficiently big. It uses U-shaped and bow tie shaped slot. The resonance frequency is much lesser ˜2.6 GHz.

Yet another reference is made to the literature “Microstrip reflective array antenna adopting a plurality of U-slot patches—N. Chang, Y. L. Liau, Application filed: 15 Aug. 2005”. It discloses the reflective disk consisting of plurality of square patch antenna on upper surface of first substrate, whereas plurality of U-slot patch is used on upper surface of second substrate. The disk is used to design wideband reflect array with center frequency 11.5 GHz.

Therefore, it is seen from the existing prior art that although several micro-strip antennas or arrays are designed for 60 GHz communications, there is a dire need of an appropriate broad-band antenna having compact size, light weight, minimum power consumption, is easy to fabricate and integrable with other devices considering the constraints such as high feed-line loss, substrate loss and the like.

### SUMMARY OF THE INVENTION

The following disclosure presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

An object of the present invention is to overcome the drawbacks of the existing prior art.

Another object of the present invention is to provide a compact size, light weight microstrip antenna for 60 GHz communications.

Yet another object of the present invention is to provide a microstrip antenna of minimum power consumption and easy fabrication.

Still another object of the present invention is to provide a microstrip antenna which is easily integrable with other devices.

Yet another object of the present invention is to reduce feed line loss, substrate loss and the like.

Briefly, various aspects of the subject matter described herein are directed at a broadband microstrip patch antenna comprising two substrate layers separated by a dielectric layer, a microstrip patch antenna having U shaped slot wherein the U shaped slot is having unequal arms fabricated on the upper surface of the material of the dielectric layer and wherein electromagnetically coupled feed is applied in the antenna to reduce the feed loss and the elements in the antenna are placed in an optimized manner.

In an aspect of the present invention, the design of the rectangular microstrip patch antenna with U-shaped slot with unequal arms and multi dielectric layer is provided to achieve broadband characteristics at 60 GHz. Further provided in present invention is the use of electromagnetically coupled feeding technique with the microstrip line on different layer from the microstrip patch to reduce the coupling of the feed line radiation with actual antenna radiation.

In another aspect of the present invention is provided the optimization of the microstrip patch dimension, slot length, widths, separation, position, orientation, height of substrate layers e.g. RT duroid 5880 and roha cell materials, width and length of microstrip feed line, substrate and ground plane size etc. using algorithm of trust region method.

In yet another aspect of the present invention is provided the selection and design of suitable wideband proximity-coupled microstrip to wave guide transition operating over the desired frequency band to be connected with the antenna for feeding and measurement of the antenna characteristics.

In another aspect of the present invention is provided an antenna that comprises U-shaped slot with unequal arms on the microstrip patch antenna together with multilayer dielectric materials to increase the impedance bandwidth. The application of electromagnetically coupled feed to appreciably reduce the feed loss and the avoidance of undesired feed radiation by the use of multilayer dielectric structures is attained by the present invention.

Other salient features and advantages of the invention will become apparent to those skilled in the art from the following detailed description, which, taken in conjunction with the annexed drawings, discloses exemplary embodiments of the invention.

### BRIEF DESCRIPTION OF THE ACCOMPANYING DRAWINGS

The above and other aspects, features, and advantages of certain exemplary embodiments of the present invention will be more apparent from the following description taken in conjunction with the accompanying drawings in which:

FIG. 1 illustrates an electromagnetically coupled microstrip patch antenna with U-shaped slot according to an embodiment of the present invention.

FIG. 2(a) illustrates the microstrip patch antenna having U-shaped slot according to an embodiment of the present invention.

FIG. 2(b) illustrates the electromagnetically coupled microstrip feed line of the antenna according to an embodiment of the present invention.

FIG. 3 illustrates the proximity coupled microstrip to waveguide transition according to an embodiment of the present invention.

FIG. 4 illustrates the layer-wise configuration of the electromagnetically coupled microstrip patch antenna with U-shaped slot with the feed line and proximity coupled microstrip to waveguide transition according to an embodiment of the present invention.

FIG. 5 illustrates the plot of S₁₁ versus frequency of the antenna according to the present invention.

FIG. 6 illustrates the 3-D radiation pattern at 60 GHz as per the present disclosure.

FIG. 7 (a) illustrates the far-field radiation pattern versus theta in degree on different planes when phi=0° as per the present disclosure.

FIG. 7 (b) illustrates the far-field radiation pattern versus theta in degree on different planes when phi=90° as per the present disclosure.

FIG. 8 illustrates the plot of Sn versus frequency of the antenna according to the present invention with microstrip to waveguide transition module.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION OF THE PRESENT INVENTION

The following description with reference to the accompanying drawings is provided to assist in a comprehensive understanding of exemplary embodiments of the invention. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by their equivalents.

It is to be understood that the singular forms “a”, “an” and “the” include plural referents unless the context clearly dictates otherwise.

By the term “substantially” wherever used or will be used later it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

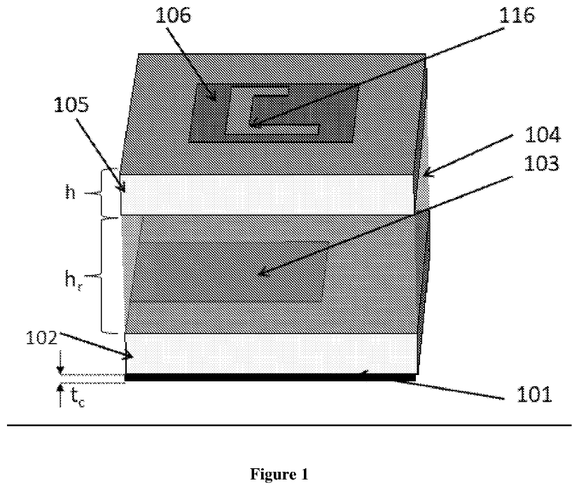

In an embodiment of the present invention is disclosed a broadband microstrip patch antenna for millimeter wave applications at 60 GHz. The present embodiment of the antenna comprises of two substrate layers of preferably RT duroid 5880 material with relative permittivity of 2.2 and thickness of 15 mil separated by another dielectric layer of relative permittivity of 1, like roha cell. The disclosed embodiment of the present invention is shown in FIG. 1. A microstrip patch antenna with U-shaped slot is printed on the upper surface of the top dielectric material. Initially the dimension of the microstrip patch is evaluated using standard formulations considering the resonance frequency as 60 GHz.

The problem with the patch antenna in general is its narrow bandwidth. Accordingly, the impedance bandwidth of the patch is increased by using U-shaped slot of suitable dimension on the patch surface. The arms of the U-slot work as separate and compactly coupled resonators. The mutual coupling between the resonators moves the resonances toward higher and lower end frequencies and thus effectively increases the overall impedance bandwidth. To avoid the feed loss at high frequency e.g. 60 GHz, the most general coaxial probe feed is avoided. The patch is fed by electromagnetic coupling with the microstrip line printed on the upper surface of the lower dielectric material. The bandwidth of the antenna is further increased by sandwiching another dielectric layer with properties similar to air between the feed line and the antenna. The roha cell is chosen as the sandwich layer which helps to increase the impedance bandwidth and the strength of the structure. The ground conducting layer is printed on the lower surface of the lower dielectric material. The antenna structure is simulated and optimized. The dimension of the patch, position and dimension of slots, height of roha cell, length, width and position of the microstrip feed line, size of the substrate all these parameters are optimized using the algorithm of Trust Region method. The description of the parameters is given in Table 1. The list of components with detailed description is given in Table 2.

FIG. 1 shows the broadband microstrip patch antenna for millimeter wave applications at 60 GHz disclosed herein. The present embodiment of the antenna comprises of three substrate layers (102, 104 and 105) with two substrate layers (102 and 105) of preferably RT duroid 5880 material with relative permittivity of 2.2 and thickness of h separated by another layer (104) of relative permittivity of 1 and thickness hᵣ. The microstrip patch antenna (106) with U-shaped slot (116) is printed on the upper surface of the top dielectric material (105). The microstrip feed line (103) is printed on the upper surface of the lower dielectric layer (102). The ground plane (101) of thickness t_{c} printed on the lower surface of the lower dielectric (102).

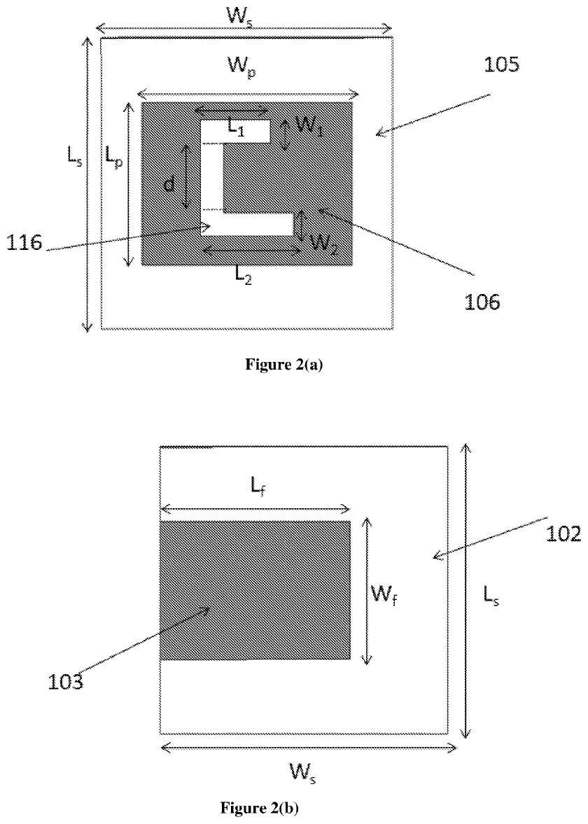

FIG. 2 (a) shows the microstrip patch (106) of the antenna disclosed herein with U-shaped slot (116). The patch is printed on the substrate layer (105) of having length L_{S} and width W_{S}. As is detailed in the figure the arms of the U-slot are of unequal length. The microstrip patch (106) is rectangular in shape and is having a width W_{P} and length L_{P}. The arms of the U slot (116) are separated by a length, d. One arm of the U-slot is of length L₁ and width W₁, while the other arm slot is of length L₂ and width W₂.

FIG. 2 (b) shows the microstrip electromagnetically coupled feed line of the antenna. The feed line (103) is printed on the substrate (102) of having length L_{S} (value same as FIG. 2(a)) and width W_{S} (value same as FIG. 2(a)) and the said feed line (103) is having a length of L_{f} and width of W_{f}. The whole antenna module further comprises a wideband proximity coupled microstrip to waveguide transition for making electrical contact with a circuit element.

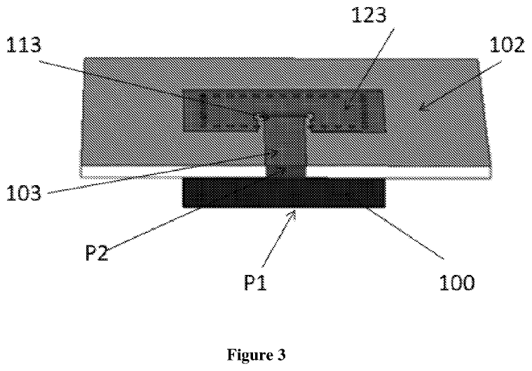

In FIG. 3, the microstrip to waveguide transition structure is shown. It consists of a microstrip line (103), planar probe (113) and waveguide short (123) printed on the upper plane of the dielectric substrate (102). The microstrip port is shown as P2. A wave guide section (100) is provided below the ground layer for connecting with wave guide port P1.

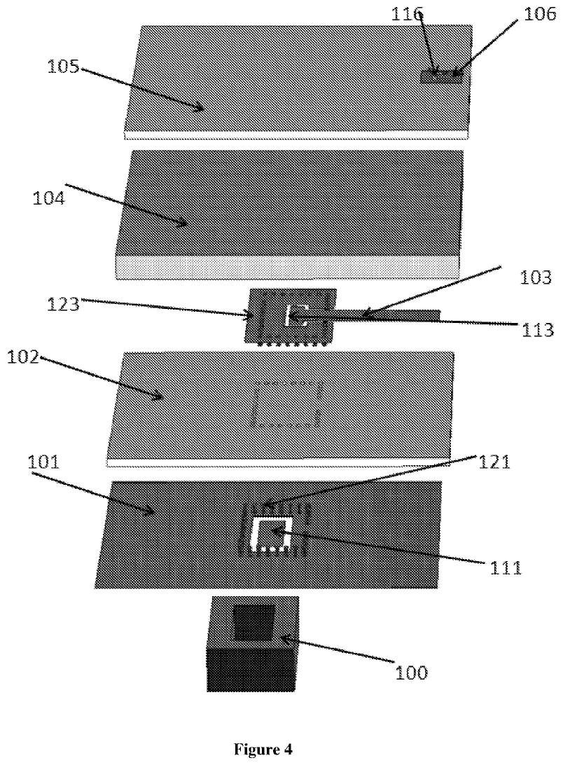

The complete antenna module is shown in FIG. 4, wherein different components of the antenna are positioned in an optimized manner. The entire module comprises of three substrate layers (102, 104 and 105) having length L_{S} (value same as FIG. 2(a)) and width W_{S} (value same as FIG. 2(a)). The 102 and 105 layers are preferably of RT duroid 5880 material with relative permittivity of 2.2 and thickness same as h in FIG. 1. The layer 104 has relative permittivity of 1 and thickness same as hᵣ as FIG. 1. The microstrip patch antenna (106) (having dimensions same as FIG. 2(a)) with U-shaped slot (116) (having dimensions same as FIG. 2(a)) are printed on the upper surface of the top dielectric material (105). The microstrip feed line (103), planar probe (113) and waveguide short (123) are printed on the upper surface of the lower dielectric layer 102. A rectangular patch (111) and surrounding ground (101) are patterned on the lower plane of the dielectric substrate. The via holes (121) surrounding the waveguide aperture printed on the lower substrate layer electrically connect the surrounding ground (101) and waveguide short (123). A waveguide (100) is provided below the ground layer having large broad walls for connecting with external port.

TABLE 1
Description of the parameters used in FIG. 1 and 2

| Parameter | Description | Values (mm) |
|---|---|---|
| L_{S} | Substrate length | 2.50 |
| W_{S} | Substrate width | 2.50 |
| Lₚ | Patch length | 1.40 |
| Wₚ | Patch width | 1.20 |
| L₁ | Length of slot 1 | 0.50 |
| L₂ | Length of slot 2 | 0.80 |
| W₁ | Width of slot 1 | 0.20 |
| W₂ | Width of slot 2 | 0.20 |
| d | Distance between two slots | 0.60 |
| hᵣ | Height of roha cell | 1.12 |
| W_{f} | Width of feed line | 1.20 |
| L_{f} | Length of feed line | 1.65 |
| h | Substrate height | 0.381 |
| t_{c} | Thickness of copper layer | 0.035 |

TABLE 2
Description of the components used in FIG. 3 and 4

| Component | Description |
|---|---|
| 100 | Waveguide |
| 101 | Ground plane |
| 111 | Rectangular patch |
| 121 | Via holes |
| 102 | Substrate (RT duroid 5880) layer 2 |
| 103 | Feed line |
| 113 | Probe |
| 123 | Waveguide short |
| 104 | Roha cell |
| 105 | Substrate (RT duroid 5880) layer 1 |
| 106 | Microstrip patch |
| 116 | U-shaped slot |
| P1 | Waveguide port 1 |
| P2 | Microstrip port 2 |

The approximate dimensions given in the table herein above are solely to provide one example, and the present inventive concepts are in no way limited to the dimensions discussed.

As an aspect of the present invention a design of 60 GHz rectangular microstrip patch antenna with U-shaped slot of unequal arms placed on the upper surface of the upper dielectric layer of a multilayer antenna structure to increase the impedance bandwidth is provided. The use of electromagnetically coupled feeding technique with the microstrip line on the upper layer of the lowest dielectric material advantageously reduces the coupling of the feedline radiation with actual antenna radiation. The low-cost substrate with low substrate loss characteristics is selected for 60 GHz operation. Suitable wideband proximity-coupled microstrip to wave guide transition operating over the desired frequency band to be connected with the antenna for feeding and measurement of the antenna characteristics is selected for the design of the antenna as per the present invention. As per another aspect of the present invention, the dimension, L_{P}×W_{P}, of the microstrip patch is optimized with the multilayer structure to achieve the desired 60 GHz resonance frequency. The selection of height hᵣ of the middle rohacell layer is made to advantageously achieve the maximum impedance bandwidth. It is an aspect of the present invention to optimize the length (L_{f}) and width (W_{f}) of the microstrip feed line to achieve the desired resonant frequency. The choice and optimization of the slot lengths L₁ and L₂ is such that the lower and upper frequencies of the desired 60 GHz frequency band are achieved. The optimization of slot widths W₁ and W₂ and the separation between the slots, d to is such that the desired impedance bandwidth is achieved. The optimization of the position and orientation of the slot is brought about by using Trust-region framework for tuning the impedance over the frequency bandwidth. The optimization of the slot widths, separation, position and orientation of the slots are to maximize and stabilize the gain of the antenna over the impedance bandwidth.

In another aspect of the present invention, the second level of optimization of microstrip patch dimension Lₚ×Wₚ with U-shaped slot of optimized parameters with multi layer structure to achieve the desired impedance bandwidth with 60 GHz resonance frequency is disclosed. As per the aspect of the present invention, the choice of the size of the substrate L_{S}×W_{S} and ground plane of antenna is made by studying the position of resonant frequency from the return loss characteristics and beam-width of the radiation pattern. The choice of the unit antenna size is determined keeping in mind the inter-element separation between the elements to be maintained to avoid the grating lobe while used in phased array configuration.

In yet another aspect of the present invention the optimization of proximity-coupled microstrip to waveguide transition is disclosed. Such optimization is for operating over the desired frequency band and it is achieved by optimizing the following parameters:
i) The length of the patch in microstrip to waveguide transition structure to achieve the desired lower resonant frequency.
ii) The distance of the via holes from the edge of the broad-wall of waveguide to achieve the higher resonant frequency.
iii) The overlap length of the inserted probe and width of the probe for impedance matching to the waveguide.
iv) The diameter and separation of via holes in order to reduce the leakage of parallel plate mode transmitting into the substrate.

It is yet another aspect of the present invention that the design of the whole antenna structure comprises the microstrip to waveguide transition, proximity-type feeding, roha cell and microstrip patch with U-shaped slot. In this aspect it is disclosed that the third level of optimization of different parameters e.g. dimension of the microstrip patch, dimension and position of U-shaped slot, length and width of the microstrip line, dimensions of the microstrip to waveguide transition are facilitated to achieve
i) Wide impedance bandwidth over the desired frequency band.
ii) Maintain stable nearly omni-directional radiation pattern with high gain over the impedance bandwidth.
iii) Minimize the coupling between the feed transition and radiating patch antenna.

In an embodiment of the present invention the microstrip antenna comprises U-shaped slot on the microstrip patch antenna together with multilayer dielectric materials to increase the impedance bandwidth. The application of electromagnetically coupled feed as per the present invention appreciably reduces the feed loss, and brings about the avoidance of undesired feed radiation by the use of multilayer dielectric structures. With the preset invention, the performance optimization of the antenna in terms of impedance bandwidth and stability of gain with omni-directional radiation pattern over impedance bandwidth is brought forth. In the present invention provides optimum microstrip to waveguide transition.

### Experimental Testing

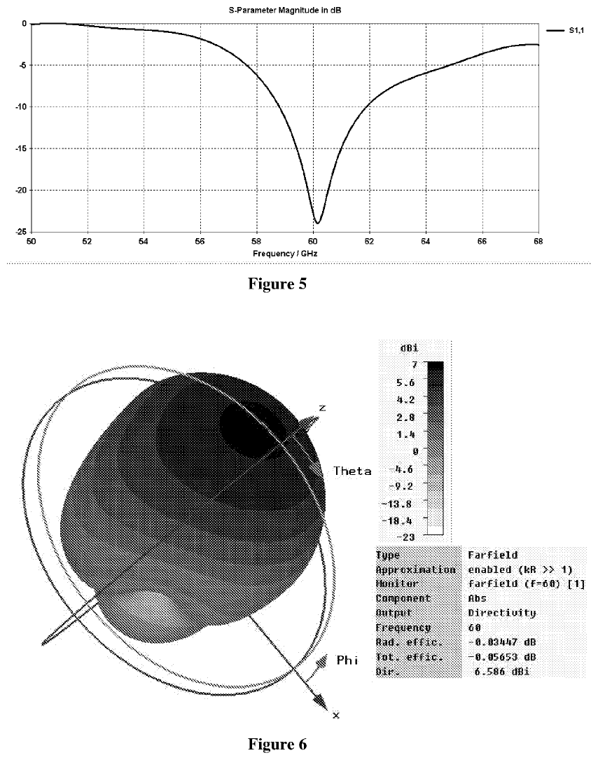

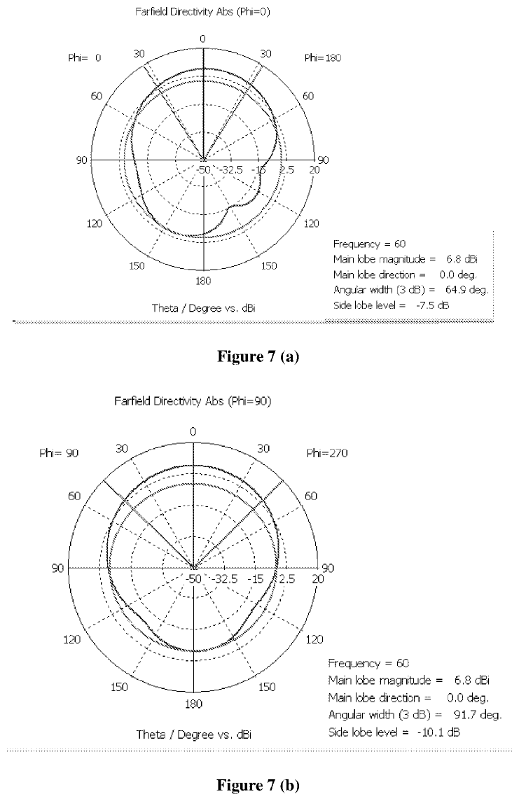

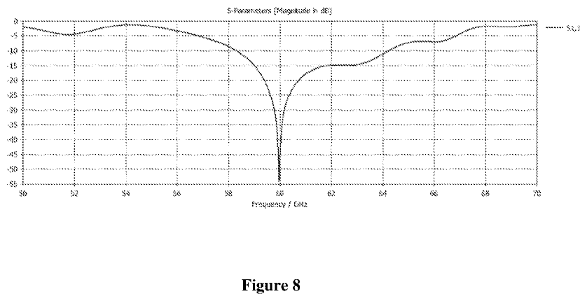

The herein disclosed invention has been experimentally tested and verified. The results for return loss, radiation pattern using the present invention have been simulated using electromagnetic software CST microwave studio and the said results are shown in FIGS. 5-8. FIG. 5 shows the plot of S₁₁ versus frequency of the proposed antenna of the present invention, as is known S₁₁ represents how much power is reflected from the antenna. The plot of S₁₁ versus frequency of the antenna shows 10 dB return loss bandwidth over 58.5-63 GHz. FIG. 6 shows the 3-D radiation pattern at 60 GHz of the proposed antenna. According to the present invention, FIG. 7 shows the far-field radiation pattern versus theta in degree on different planes (a) phi=0° and (b) phi=90°. The antenna shows nearly omni-directional radiation pattern over the frequency bandwidth. FIG. 8 shows the plot of S₁₁ versus frequency of the antenna of the present invention with microstrip to waveguide transition module.

To study the effect of the feed transition in the prototype antenna before fabrication, the antenna structure is added with a millimeter wave wideband proximity-coupled microstrip to waveguide transition, as seen in FIG. 4. It further shows the fabrication of the different elements of the antenna, such as probe, ports (P1, P2), waveguide short, microstrip line and the like on the substrate layer. The whole structure is simulated and optimized considering the coupling between the transition, feed structure and antenna itself. The fabrication of the prototype antenna is underway to verify and compare the simulated results with experimental data. FIG. 4 discloses the layer-wise configuration of the proximity coupled microstrip antenna with microstrip to waveguide transition of the present invention. FIG. 8 discloses the plot of S₁₁ versus frequency of the proposed antenna as per the present invention with microstrip to waveguide transition module.

Some of the noteworthy features of the present invention are mentioned below:
With the present invention, a wide impedance bandwidth (˜4.5 GHz) compared to a traditional microstrip patch antenna is achieved using U-shaped slot and multilayer dielectric material to increase the effective height of the dielectric material.
With the present invention, stable nearly omni-directional radiation pattern with main lobe magnitude of ˜6.8 dBi over the impedance bandwidth is achieved.
The present invention facilitates for low feed loss using electromagnetically coupled feed mechanism which is suitable for high frequency applications.
Low coupling between feed line radiation and actual antenna radiation due to the presence of the substrate layer over the feed line.
Although the antenna structure disclosed herein has used three substrate layers, it can be realized by stacking single layer structures which in turn can be fabricated using conventional low cost single layered printed circuit hoards. Thus, the present invention is cost effective in nature.
The small sized antenna can be fitted within the inter-element spacing for the design of the appropriate phased array antenna with good scanning performance thus avoiding the grating lobe.
The antenna disclosed herein, with suitable corporate/parallel feeding may be used for array design with good directive radiation pattern.
The herein disclosed antenna element can be advantageously integrated with other front-end components to design the phased array panel for the application in 5G communications.
The herein disclosed antenna is so designed that as a whole it includes suitable feeding mechanism together with the microstrip to waveguide transition to estimate the performance of the antenna accurately before fabrication of the prototype.

The raw material requirement of the present invention comprises substrate material RT Duroid 5880 with relative permittivity of 2.2 and thickness of 0.381 mm (15 mil) with ½ oz., copper cladding on both sides, and Roha cell material with relative permittivity of 1.0. The antenna disclosed in the present invention can used in the design of the phased array panel for the application in 5G communications for beamforming. It can be used in Millimeter wave Intelligent Transportation System design such as automotive radar. It may also be used in Multiple Input Multiple Output (MIMO) application for ultra high data rate 5G system design. The present invention may be useful for the design of low profile, efficient beamforming antenna array providing reliable interference-free communication between high performing, high speed, wideband millimeter wave Internet of Things (IoT) devices. The millimeter wave antenna design for imaging with good resolution and reduced penetration depth to be used for medical application, security scanning and the like.

1. A broadband microstrip patch antenna comprising:
two substrate layers (102, 105) separated by a dielectric layer (104);
a microstrip patch antenna (106) having U-shaped slot (116) wherein the U-shaped slot is having unequal arms and is fabricated on an upper surface of the material of the dielectric layer (105); and
wherein an electromagnetically coupled feed is applied in the antenna (106) to reduce the feed loss and the elements in the antenna are placed in an optimized manner.

2. The antenna as claimed in claim 1, wherein relative permittivity of the substrate layers (102, 105) is preferably 2.2 and the thickness of the substrate layer is 15 mil.

3. The antenna as claimed in claim 1, wherein relative permittivity of the roha cell dielectric layer (104) is 1.

4. The antenna as claimed in claim 1, wherein the arms of the U-shaped slot (116) is adapted to be separate and is adapted to function as compactly coupled resonators.

5. The antenna as claimed in claim 1, wherein the antenna patch (106) is fed by electromagnetic coupling with a microstrip line (103) fabricated on an upper surface of a lower layer of the dielectric material.

6. The antenna as claimed in claim 1, wherein another dielectric layer (104) is sandwiched between the feedline (103) and the antenna patch (106), wherein the said dielectric layer is having properties similar to air.

7. The antenna as claimed in claim 1, wherein the material of the substrate is RT duroid 5880 material.

8. The antenna as claimed in claim 1, wherein the dielectric layer is roha cell.

9. The antenna as claimed in claim 1, wherein a ground conducting layer is fabricated on the lower surface of the lower material of the dielectric layer.

10. The antenna as claimed in claim 1, wherein the said antenna further comprises a wideband proximity coupled microstrip to waveguide transition for making electrical contact with a circuit element, a waveguide is provided below the ground layer, wherein the waveguide is having large broad walls, wherein the different components of the antenna are position in an optimized manner.

11. The antenna as claimed in claim 1, wherein the microstrip to waveguide transition structure comprises a microstrip line (103), a planar probe (113), a waveguide short (123) printed on the upper plane of the dielectric substrate and a rectangular patch element (111); wherein the surrounding ground (101) is adapted to be patterned on the lower plane of the dielectric substrate with via holes (121) surrounding the waveguide aperture printed on the lower substrate layer adapted to be electrically connecting surrounding ground (101) and waveguide short (123).

12. The antenna as claimed in claim 1, wherein the microstrip patch antenna is rectangular.

13. The antenna as claimed in claim 1, wherein the height of the dielectric layer is selected such that maximum impedance bandwidth is attained.

14. The antenna as claimed in claim 1, wherein the antenna size is so selected to maintain an inter-element separation between the elements and to avoid the grating lobe when the antenna is used in phased array configuration.

15. The antenna as claimed in claim 1, wherein the operation of the antenna over the desired frequency band is achieved by a second level of optimization, and the said antenna is configured for operating in 60 GHz millimeter wave phased array.

16. The antenna as claimed in claim 14, wherein the operation of the antenna over the desired frequency band is achieved by optimizing the length of the patch (111) in microstrip to waveguide transition structure to attain a desired lower resonant frequency.

17. The antenna as claimed in claim 15, wherein the operation of the antenna over the desired frequency band is achieved by optimizing the distance of the via holes from an edge of the broad-wall of the wave guide (100) to attain a higher resonant frequency.

18. The antenna as claimed in claim 15, wherein the operation of the antenna over the desired frequency band is achieved by optimizing an overlap length of the inserted probe and width of the probe for impedance matching to the waveguide (100).

19. The antenna as claimed in claim 15, wherein the operation of the antenna over the desired frequency band is achieved by optimizing the diameter and the separation of the via holes (121) to reduce the leakage of a parallel plate mode transmitting into the substrate.

20. The antenna as claimed in claim 1, wherein the operation of the antenna over the desired frequency band is achieved by a third level of optimization of different parameters.
